(19) United States
(12) Patent Application Publication
(10) Pub. No.: US 2023/0162129 A1
(43) Pub. Date: May 25, 2023

(54) WAYBILL INFORMATION PROCESSING METHOD

(71) Applicant: HEFEI WEITIANYUNTONG INFORMATION TECHNOLOGY CO., LTD, Anhui (CN)

(72) Inventor: Guangcai FU, Anhui (CN)

(73) Assignee: HEFEI WEITIANYUNTONG INFORMATION TECHNOLOGY CO., LTD, Anhui (CN)

(21) Appl. No.: 17/773,848

(22) PCT Filed: Jun. 30, 2021
(86) PCT No.: PCT/CN2021/103581

§ 371 Date: May 3, 2022

(30) Foreign Application Priority Data
Dec. 7, 2020 (CN) 202011416487.3

(51) Int. Cl. G06Q 10/0833; G06Q 10/087

(52) U.S. Cl. CPC G06Q 10/0833; G06Q 10/087

(57) ABSTRACT

A waybill information processing method, includes: when a waybill business processing center receives the log-in request of a transport terminal, recording location information of the current transport terminal, wherein the waybill business processing center is provided with a function module for processing the waybill business; using the waybill business processing center to deliver the location information to each waybill transport node component for storage, and returning the waybill transport node component list and component mapping relationship to the transport terminal. The component mapping relationship is the corresponding relationship between the component identifier of the waybill transport node and the waybill information resource; acquiring a business processing request through the waybill transport node component. The business processing request is a request sent by the transport terminal to the specified waybill transport node component according to the list of waybill transport node components and the component mapping relationship.

The present application claims priority to Chinese patent application NO. 202011416487.3, filed to the Chinese Patent Office on Dec. 7, 2020, entitled “Waybill information processing method”, the entire disclosure of which is incorporated herein by reference.

### TECHNICAL FIELD

The application relates to the field of waybill management, and in particular to a waybill information processing method.

### BACKGROUND ART

With the development of transportation business, the three-party system is connected. Corresponding to the ability to open the new waybill and the positioning track from the three-party system, the actual situation of the waybill needs to be verified. Existing verification of origin and destination coverage cannot really verify the authenticity of the waybill, and there is a possibility that it can be forged. In order to ensure the authenticity of the business, it is necessary to verify the authenticity of the waybill.

In the prior art, the waybill needs to go through multiple transfer nodes during the transportation process. However, location information registration is often performed only after arriving at a certain fixed place, such as a storage warehouse, to form a trajectory path, but there is still a problem that the location information between two points is blank and difficult to verify. Therefore, developing a waybill information processing method with better verifiability is an urgent technical problem to be solved.

### SUMMARY OF THE APPLICATION

In order to solve the technical problems existing in the background art, the present application proposes a waybill information processing method.

The present application proposes a waybill information processing method, comprising:

when a waybill business processing center receives the log-in request of a transport terminal, recording location information of the current transport terminal, wherein the waybill business processing center is provided with a function module for processing the waybill business;

using the waybill business processing center to deliver the location information to each waybill transport node component for storage, and returning the waybill transport node component list and component mapping relationship to the transport terminal, wherein the component mapping relationship is the corresponding relationship between the component identifier of the waybill transport node and the waybill information resource;

acquiring a business processing request through the waybill transport node component, wherein the business processing request is a request sent by the transport terminal to the specified waybill transport node component according to the list of waybill transport node components and the component mapping relationship;

if the waybill transport node component passes the verification of the business processing request of the transport terminal according to the location information stored by itself, allowing the waybill transport node component to respond to the business processing request and return the request processing result to the transport terminal.

Wherein, after acquiring the business processing request through the waybill transport node component, the method further comprises: using the waybill transport node component to determine whether the business processing request needs to verify the operation authority. If not, the waybill transport node component directly performs information verification on the transport terminal according to the position information stored by itself. If yes, the waybill transport node component forwards the business processing request to the waybill business processing center for authorization verification. And after the authority verification is passed, the information verification of the transport terminal is performed by the waybill transport node component according to the position information saved by itself.

Wherein, after the waybill business processing center receives the logout request from the transport terminal, the waybill business processing center saves the location information of the current transport terminal, and sends an update request to each waybill transport node component, so that each waybill transport node component saves the location information.

Wherein, if the waybill transport node component passes the verification of the business processing request of the transport terminal according to the location information stored by itself, allowing the waybill transport node component to respond to the business processing request and return the request processing result to the transport terminal, comprises:

if the waybill transport node component passes the verification of the business processing request of the transport terminal according to the location information stored by itself, using the waybill transport node component to determine whether other waybill transport node components need to be called in response to the business processing request;

if not, the waybill transport node component responds to the business processing request, and returns the request processing result to the transport terminal; if yes, an addressing request is sent to the waybill service processing center according to the waybill transport node component identifier to acquire the waybill information resource corresponding to the target waybill transport node component;

sending the business processing request to the target waybill transport node component for processing through the bus between the components, and a corresponding request processing result is obtained and returned to the transport terminal.

Wherein, the component registration/update request is acquired through the waybill business processing center, and the component mapping relationship is modified according to the component registration/update request; If there is currently a registered transport terminal, the modified component mapping relationship is automatically pushed to the registered transport terminal.

Wherein, acquiring a business processing request through the waybill transport node component comprises acquiring the business processing request by using the waybill business processing center, and forwarding the business processing request to the corresponding waybill transport node component according to the component identifier specified by the business process request.

As can be seen through the above scheme, the present application proposes a waybill information processing method, comprising: when a waybill business processing center receives the log-in request of a transport terminal, recording location information of the current transport terminal, wherein the waybill business processing center is provided with a function module for processing the waybill business; using the waybill business processing center to deliver the location information to each waybill transport node component for storage, and returning the waybill transport node component list and component mapping relationship to the transport terminal, wherein the component mapping relationship is the corresponding relationship between the component identifier of the waybill transport node and the waybill information resource; acquiring a business processing request through the waybill transport node component, wherein the business processing request is a request sent by the transport terminal to the specified waybill transport node component according to the list of waybill transport node components and the component mapping relationship; if the waybill transport node component passes the verification of the business processing request of the transport terminal according to the location information stored by itself, allowing the waybill transport node component to respond to the business processing request and return the request processing result to the transport terminal.

As can be seen from the above, the application obtains the waybill business processing center through the functional module for processing the waybill business. At the same time, the design of the transport terminal is added, which can realize the characteristics of the mobile terminal along with the transport vehicle, so as to acquire real-time location information on the one hand, and also process the waybill business in real time on the other hand. On this basis, it will bring pressure on the processing capacity of the waybill. In this scheme, the waybill transport node components are designed in a componentized form, which can reduce the pressure on the business processing center, and form a corresponding relationship between the waybill transport node components and the waybill information resources, and use the method of list refresh to reduce the amount of information communication. In the above scheme design, the location information of the transport terminal and the query ability of the waybill have been significantly improved, and the real-time synchronization, verification and query of the waybill information have been realized.

### BRIEF DESCRIPTION OF DRAWING

FIG. 1 is a flowchart of a waybill information processing method proposed by the present application.

### DETAILED DESCRIPTION OF THE EMBODIMENTS

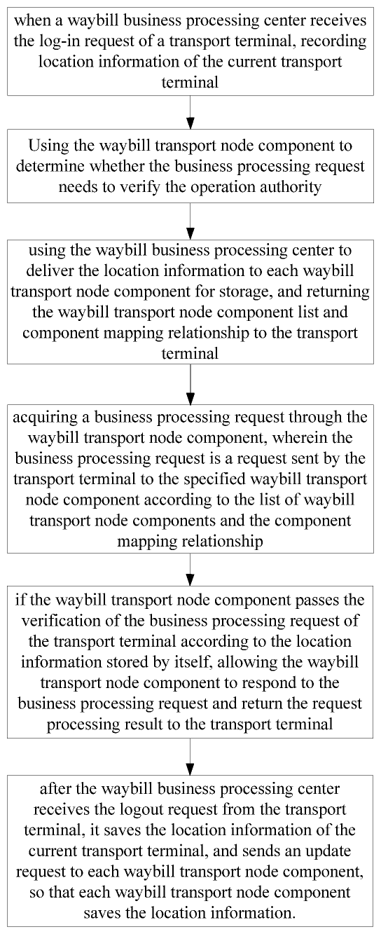

As shown in FIG. 1, FIG. 1 is a flowchart of a waybill information processing method proposed by the present application.

Referring to FIG. 1, the present application proposes a waybill information processing method, comprising:

when a waybill business processing center receives the log-in request of a transport terminal, recording location information of the current transport terminal, wherein the waybill business processing center is provided with a function module for processing the waybill business;

using the waybill business processing center to deliver the location information to each waybill transport node component for storage, and returning the waybill transport node component list and component mapping relationship to the transport terminal, wherein the component mapping relationship is the corresponding relationship between the component identifier of the waybill transport node and the waybill information resource;

acquiring a business processing request through the waybill transport node component, wherein the business processing request is a request sent by the transport terminal to the specified waybill transport node component according to the list of waybill transport node components and the component mapping relationship;

if the waybill transport node component passes the verification of the business processing request of the transport terminal according to the location information stored by itself, allowing the waybill transport node component to respond to the business processing request and return the request processing result to the transport terminal.

In this embodiment of the present invention, after acquiring the business processing request through the waybill transport node component, the method further comprises:

using the waybill transport node component to determine whether the business processing request needs to verify the operation authority.

If not, the waybill transport node component directly performs information verification on the transport terminal according to the position information stored by itself.

If yes, the waybill transport node component forwards the business processing request to the waybill business processing center for authorization verification. And after the authority verification is passed, the information verification of the transport terminal is performed by the waybill transport node component according to the position information saved by itself.

In the above scheme, the legality control of the capacity side can be improved. If no authority control is required, the waybill transport node component directly performs information verification. If the relevant request involves permission control, the authorization verification will be carried out by the waybill business processing center. Wherein, the operation authority verification method is to verify according to cookie or IP record. The information verification method is to use the pop-up window to log in to the account or to use the international verification code for verification.

In this embodiment of the present invention, after the waybill business processing center receives the logout request from the transport terminal, it saves the location information of the current transport terminal, and sends an update request to each waybill transport node component, so that each waybill transport node component saves the location information. In this technical solution, when the service processing request submitted by the transport terminal is completed, the transport terminal will be logged out. At this time, the location information will be updated once.

In this embodiment of the present invention, if the waybill transport node component passes the verification of the business processing request of the transport terminal according to the location information stored by itself, allowing the waybill transport node component to respond to the business processing request and return the request processing result to the transport terminal, comprises:

if the waybill transport node component passes the verification of the business processing request of the transport terminal according to the location information stored by itself, using the waybill transport node component to determine whether other waybill transport node components need to be called in response to the business processing request;

if not, the waybill transport node component responds to the business processing request, and returns the request processing result to the transport terminal;

if yes, an addressing request is sent to the waybill service processing center according to the waybill transport node component identifier to acquire the waybill information resource corresponding to the target waybill transport node component;

sending the business processing request to the target waybill transport node component for processing through the bus between the components, and a corresponding request processing result is obtained and returned to the transport terminal.

Through the above embodiment, if the waybill transport node cannot complete the business request task, the task can be directly transmitted to other waybill data nodes without through the waybill business processing center, thereby reducing system resource consumption.

In this embodiment of the present invention, the component registration/update request is acquired through the waybill business processing center, and the component mapping relationship is modified according to the component registration/update request; If there is currently a registered transport terminal, the modified component mapping relationship is automatically pushed to the registered transport terminal. By this design, the whole waybill information processing system can be updated.

In this embodiment of the present invention, acquiring a business processing request through the waybill transport node component comprises acquiring the business processing request by using the waybill business processing center, and forwarding the business processing request to the corresponding waybill transport node component according to the component identifier specified by the business process request. By this design, under extreme information processing tasks, the waybill transport node components are allowed to share the processing pressure of the waybill business processing center, and the waybill business processing center only performs transit operations.

In this embodiment, the application obtains the waybill business processing center through the functional module for processing the waybill business. At the same time, the design of the transport terminal is added, which can realize the characteristics of the mobile terminal along with the transport vehicle, so as to acquire real-time location information on the one hand, and also process the waybill business in real time on the other hand. On this basis, it will bring pressure on the processing capacity of the waybill. In this scheme, the waybill transport node components are designed in a componentized form, which can reduce the pressure on the business processing center, and form a corresponding relationship between the waybill transport node components and the waybill information resources, and use the method of list refresh to reduce the amount of information communication. In the above scheme design, the location information of the transport terminal and the query ability of the waybill have been significantly improved, and the real-time synchronization, verification and query of the waybill information have been realized.

The above is only the preferred embodiment of the present application, but the scope of protection of the present application is not limited thereto, and any equivalents or modifications of the technical solutions of the present application and the application concept thereof should be comprised in the scope of the present application within the scope of the technical scope of the present application.

What is claimed is:

1. A waybill information processing method, comprising:
when a waybill business processing center receives the log-in request of a transport terminal, recording location information of the current transport terminal, wherein the waybill business processing center is provided with a function module for processing the waybill business;
using the waybill business processing center to deliver the location information to each waybill transport node component for storage, and returning the waybill transport node component list and component mapping relationship to the transport terminal, wherein the component mapping relationship is the corresponding relationship between the component identifier of the waybill transport node and the waybill information resource;
acquiring a business processing request through the waybill transport node component, wherein the business processing request is a request sent by the transport terminal to the specified waybill transport node component according to the list of waybill transport node components and the component mapping relationship;
if the waybill transport node component passes the verification of the business processing request of the transport terminal according to the location information stored by itself, allowing the waybill transport node component to respond to the business processing request and return the request processing result to the transport terminal.

2. The method for processing waybill information according to claim 1, wherein, after acquiring the business processing request through the waybill transport node component, the method further comprises: using the waybill transport node component to determine whether the business processing request needs to verify the operation authority; if not, the waybill transport node component directly performs information verification on the transport terminal according to the position information stored by itself; if yes, the waybill transport node component forwards the business processing request to the waybill business processing center for authorization verification; and after the authority verification is passed, the information verification of the transport terminal is performed by the waybill transport node component according to the position information saved by itself.

3. The method for processing waybill information according to claim 1, wherein, after the waybill business processing center receives the logout request from the transport terminal, the waybill business processing center saves the location information of the current transport terminal, and sends an update request to each waybill transport node component, so that each waybill transport node component saves the location information.

4. The method for processing waybill information according to claim 1, wherein, if the waybill transport node component passes the verification of the business processing request of the transport terminal according to the location information stored by itself, allowing the waybill transport node component to respond to the business processing request and return the request processing result to the transport terminal, comprises:
if the waybill transport node component passes the verification of the business processing request of the transport terminal according to the location information stored by itself, using the waybill transport node component to determine whether other waybill transport node components need to be called in response to the business processing request;
if not, the waybill transport node component responds to the business processing request, and returns the request processing result to the transport terminal; if yes, an addressing request is sent to the waybill service processing center according to the waybill transport node component identifier to acquire the waybill information resource corresponding to the target waybill transport node component;
sending the business processing request to the target waybill transport node component for processing through the bus between the components, and a corresponding request processing result is obtained and returned to the transport terminal.

5. The method for processing waybill information according to claim 1, wherein, the component registration/update request is acquired through the waybill business processing center, and the component mapping relationship is modified according to the component registration/update request; if there is currently a registered transport terminal, the modified component mapping relationship is automatically pushed to the registered transport terminal.

6. The method for processing waybill information according to claim 1, wherein, acquiring a business processing request through the waybill transport node component comprises acquiring the business processing request by using the waybill business processing center, and forwarding the business processing request to the corresponding waybill transport node component according to the component identifier specified by the business process request.
